(19) United States
(12) Patent Application Publication
(10) Pub. No.: US 2026/0116234 A1
(43) Pub. Date: Apr. 30, 2026

(54) METHOD FOR CONTROLLING A CHARGING PROCESS OF A TRACTION BATTERY OF AN ELECTRIC-POWERED MOTOR VEHICLE

(71) Applicant: Volkswagen Aktiengesellschaft, Wolfsburg (DE)

(72) Inventor: Lukas Tjaard BRAND, Wolfsburg (DE)

(73) Assignee: Volkswagen Aktiengesellschaft, Wolfsburg (DE)

(21) Appl. No.: 19/371,257

(22) Filed: Oct. 28, 2025

(30) Foreign Application Priority Data
Oct. 28, 2024 (DE) 10 2024 131 299.8

(51) Int. Cl. B60L 53/60; B60L 53/16; G07C 5/08; H02J 7/00

(52) U.S. Cl. CPC B60L 53/60; B60L 53/16; G07C 5/0816; H02J 7/975

(57) ABSTRACT

A method for controlling a charging process of a traction battery of an electric-powered motor vehicle, which has the traction battery, a charging socket for charging the traction battery, and an input device for a user. A first threshold value or a second threshold value for a temperature of the charging socket is set for a charging process depending on an input at the input device. The first threshold value is between about 80° C. and 95° C. and the second threshold value is between about 95° C. and 150° C. The charging process of the traction battery is controlled in such a way that the temperature of the charging socket does not exceed the first threshold value if the first threshold value has been set, and in such a way that the temperature of the charging socket does not exceed the second threshold value if the second threshold value has been set.

This nonprovisional application claims priority under 35 U.S.C. § 119(a) to German Patent Application No. 10 2024 131 299.8, which was filed in Germany on Oct. 28, 2024, and which is herein incorporated by reference.

### BACKGROUND OF THE INVENTION

### Field of the Invention

The invention relates to a method for controlling a charging process of a traction battery of an electric-powered motor vehicle. Furthermore, the invention relates to such an electric-powered motor vehicle.

### Description of the Background Art

An electric-powered vehicle typically has a traction battery (high-voltage battery, HV battery), which supplies an electric motor with energy to drive the vehicle. In particular, an electric-powered vehicle may be understood to be an electric vehicle that only stores the energy, required for propulsion, in the traction battery (BEV, battery electric vehicle), an electric vehicle with a range extender (REEV, range extended electric vehicle), a hybrid vehicle (HEV, hybrid electric vehicle), a plug-in hybrid electric vehicle (PHEV, plug-in hybrid electric vehicle), and/or a fuel cell vehicle (FCEV, fuel cell electric vehicle), which temporarily stores the electrical energy generated by a fuel cell in the traction battery.

The electric-powered motor vehicle expediently comprises a charging socket, which can be coupled to a charging plug of a charging device, for example, a charging station, to charge the traction battery. When charging the traction battery, the charging socket, in particular its electrical contacts (charging socket pins), can heat up, depending on the charging power and charging duration, due to contact resistances between the charging plug and charging socket.

With relatively high temperatures of the charging socket, especially its electrical contacts, there is disadvantageously the risk that a user can burn themselves, for example, when pulling the charging plug out of the charging socket.

To avoid such high temperatures in the charging socket, the charging power can be reduced accordingly, for example, or the charging process can even be stopped. The disadvantage is that the charging process is extended in this way or the traction battery is not fully charged.

Furthermore, if a predefined threshold value is exceeded, in particular 85° C., at which a risk of burns is assumed in accordance with DIN ISO 13732-1:2006 (D) for a contact time of 1 s, an lock can remain active so that the charging plug cannot be pulled out of the charging socket. The lock is then only released after the charging socket has cooled down below the threshold value. The disadvantage is that the user cannot release the lock himself before the temperature falls below the threshold value. Continuing to drive immediately after the end of the charging process is therefore not possible.

A method for operating a charging connection device for electric vehicles is known from DE 10 2012 103 213 A1, which corresponds to US 2015/0054462, wherein the charging connection device comprises a housing and wherein at least one temperature value inside the housing is detected constantly with at least one temperature sensor. Furthermore, if a first limit temperature is exceeded, the maximum permissible charging current is reduced to a specific value greater than zero. The charging process is interrupted after a defined first period of time in which the first limit temperature has been continuously exceeded or if the second limit temperature, higher than the first limit temperature, has been exceeded.

DE 10 2017 209 450 A1 describes a method for determining temperature information relating to the temperature of a charging interface, wherein the charging interface is arranged on a current path between a charging station and an electrical energy storage device of a vehicle. The method comprises determining target information relating to a target charging power. In addition, the method comprises determining actual information relating to an actual charging power taken up by the energy storage device. Furthermore, the method comprises determining the temperature information on the basis of the target information and on the basis of the actual information.

DE 10 2019 132 027 A1 relates to a portable plug-in power supply for temporarily connecting an electric-powered motor vehicle to a power supply, wherein the plug-in power supply has a vehicle connection and a grid connection. In the plug-in power supply unit, a converter circuit is set up to convert between a line voltage of a power grid and a battery voltage of a motor vehicle. A control circuit is set up to regulate and/or limit an electrical power transferred by the converter circuit between the vehicle connection and the grid connection to a reference value and to set the reference value by means of an assignment rule as a function of a respective temperature signal from a temperature sensor.

### SUMMARY OF THE INVENTION

It is therefore an object of the present invention to provide a particularly suitable method for charging the traction battery of an electric-powered motor vehicle. In particular, the charging power should be as high as possible and/or the danger to the user should be as low as possible. Furthermore, such a motor vehicle, a computer program, and a computer-readable medium with such a computer program are to be provided.

The examples and features made in connection with the method also apply correspondingly to the vehicle, to the computer program, and to the computer-readable medium, and vice versa.

The method is used to control a charging process of a traction battery, also known as a high-voltage battery, of an electric-powered motor vehicle. The vehicle comprises the traction battery and a charging socket for charging the traction battery. The charging socket, in particular its electrical contacts (charging socket pins), is electrically connected and/or can be connected to the traction battery. Furthermore, the charging socket is designed so that a charging plug of a charging device, for example, a charging station, can be coupled to the charging socket, in particular plugged into it, in order to transfer electrical energy to the traction battery.

Furthermore, the motor vehicle also has an input device for a user. A user can therefore make an entry using the input device. For example, the input device is designed as a touch display, a button, a microphone for voice input, or the like.

According to the method, a first threshold value or a second threshold value for a temperature of the charging socket, in particular for the temperature of one of its charging socket pins, is first set for a charging process depending on an input made at the input device, in particular by a user of the motor vehicle. Expediently, the input is designed in such a way that, depending on it, only either the first or the second threshold value is set. Expediently, in this case, these two setting options, therefore, the first and second threshold values, are mutually exclusive alternatives, exactly one of which is set and/or selected depending on the input.

For example, to this end the input or corresponding data or signals are transmitted to a control device of the motor vehicle and evaluated by it to determine which of the two threshold values should be set. In particular, to this end, one of the two threshold values is assigned to the input. Expediently, the (first or second) threshold value assigned in this way and selected accordingly is stored in a memory of the motor vehicle. Consequently, this can be called up for a subsequent charging process. Expediently, there are only the first and second threshold values, one of which is and/or will be set; in other words, there are no other threshold values for this setting process.

The first threshold value is between 80° C. and 95° C. For example, the first threshold value is 85° C., wherein a risk of burns is assumed at this temperature in accordance with DIN ISO 13732-1:2006 (D) for a contact time of 1 s. The second threshold value is between 95° C. and 150° C., in particular between 100° C. and 130° C. In summary, the second threshold value is greater than the first threshold value.

Subsequent to this setting of the first or second threshold value as the threshold value for the temperature of the charging socket, the traction battery is charged. This charging process is expediently controlled in so doing by means of the control device of the motor vehicle, in such a way that the temperature of the charging socket, in particular its charging socket pins, does not exceed the first threshold value if the first threshold value has been set, in particular depending on the input. Expediently, the first threshold value for charging the traction battery is set as the default value, therefore, as a preset value. Therefore, if no input has yet been made, or if the first threshold value has been set depending on the input, the traction battery is charged in such a way that the temperature of the charging socket does not exceed the first threshold value. In other words, the first threshold value is used as the threshold value for the temperature of the charging socket.

If, in contrast, the second threshold value has been set, in particular depending on the input, the charging process is controlled, in particular by means of the control device of the motor vehicle, in such a way that the temperature of the charging socket, in particular its charging socket pins, does not exceed the second threshold value. In other words, the second threshold value is used as the threshold value for the temperature of the charging socket. In particular, the charging process is controlled here independently of the first threshold value.

Expediently, in order to maintain the respective threshold value, the charging current and/or the charging power are adjusted accordingly so that this threshold value is not exceeded. If necessary, the charging power is reduced at least temporarily and/or the charging process is interrupted or aborted, and therefore no electrical energy is transferred to the traction battery.

Expediently, the charging socket has at least one temperature sensor, which is used to detect the temperature of the charging socket, in particular at least one of its charging socket pins.

In summary, the setting made, therefore, the set first or set second threshold value, is used for the subsequent charging process following this setting process. Expediently, this setting is used for all subsequent charging processes, at least until another threshold value is set on the basis of a further input and/or if another user is using the vehicle and has set another threshold value or another threshold value is preset.

Expediently, in particular for a relatively high charging power and/or for a relatively short charging time, the traction battery is charged in such a way that the temperature of the charging socket, in particular its charging socket pins, exceeds the first threshold value if the second threshold value has been set.

The user determines the maximum temperature of the charging socket during the charging process based on the input. When setting the second threshold value, a relatively high temperature is therefore advantageously permitted, and thus a relatively high charging power, and, if necessary, a charging time is reduced.

The motor vehicle furthermore expediently comprises an output device. For example, the output device is a loudspeaker, a display, or the touch display for input. According to an example, a notification for carrying out the input using the input device is output by means of the output device. According to the notification, a risk of burns may exist for the user and/or be increased when touching the charging socket after the charging process if the second threshold value is set, therefore, if an input is made that results in the setting of the second threshold value.

It is expedient to output the notification before or at the same time as providing an input option and/or an input screen for the input.

In summary, the temperature of the charging socket can exceed the first threshold value when charging with the set second threshold value, so that there is a relatively high risk of burns when touching the charging socket, especially its charging socket pins. The setting of the second threshold value and of the possibly relatively high charging socket temperature associated therewith is carried out on the basis of a intentional input by the user with knowledge of the possible risk of burns. The user is therefore aware of this danger and can therefore better avoid a burn.

In particular, if the second threshold value has been set, according to an example, a (further) notification is output, in particular to the user, when the temperature of the charging socket reaches and/or exceeds the first threshold value, in particular at the end of the charging process, therefore directly after the electrical energy has been transferred to the traction battery. This is done, for example, using the output device or another (second) output device. In this way, the user is warned of a temperature of the charging socket at which there is a risk of burns when touching the charging socket pins and/or this temperature is relatively high.

In particular, if the second threshold value has been set, a locking of the charging plug in the charging socket is released irrespective of the temperature of the charging socket according to an example. The locking is therefore also released if the temperature exceeds the first threshold value and there is a relatively high risk of burns. The locking is expediently released directly after the end of the charging process, therefore immediately after the transfer of electrical energy to the traction battery and/or immediately after any data transfer between the vehicle optionally required for this purpose. Thus, the removal of the charging plug immediately after the charging process has been completed is advantageously made possible, so that continuing a journey is made possible. It is therefore not necessary to wait for the charging socket to cool down as described above.

A further aspect of the invention relates to an electric-powered motor vehicle which is designed in such a way that its traction battery is charged and/or can be charged in accordance with one of the method variants described above.

The electric-powered motor vehicle, also referred to here and in the following as a motor vehicle or vehicle for short, has the traction battery and the charging socket for charging the traction battery for this purpose. Furthermore, the vehicle comprises the input device for a user, as well as a control device for carrying out the method in one of the method variants shown above. The charging socket expediently comprises a temperature sensor, coupled to the control device in terms of signal and/or data transmission, for detecting the temperature of the charging socket, in particular of one or all charging socket pins.

The control device is, for example, a controller or the battery management system (BMS) of the motor vehicle and/or comprises the battery management system.

In summary, the control device is provided and set up so that the first or second threshold value for a subsequent charging process is set depending on an input at the input device. Furthermore, the control device is provided and set up to control the charging process of the traction battery in such a way that the temperature of the charging socket does not exceed the first threshold value if the first threshold value has been set. Furthermore, the control device is provided and set up to control the charging process of the traction battery in such a way that the temperature of the charging socket does not exceed the second threshold value if the second threshold value has been set, wherein preferably the temperature of the charging socket can and/or does exceed the first threshold value.

For this purpose, the control device can be suitably coupled in terms of signal and/or data transmission to a motor vehicle charging circuit, expediently connected between the charging socket and the traction battery, and/or to a charging circuit of the charging device. The control device can thus transmit commands to the respective charging circuit. The commands cause the charging current and/or the charging power to be set such that the set first or second threshold value for the temperature of the charging socket is not exceeded.

In summary, the motor vehicle thus comprises electrical components adapted such that the steps of the method are carried out.

Optionally, the vehicle furthermore comprises the output device and/or the second output device.

Optionally, the vehicle's charging socket comprises a locking mechanism that can be controlled by the control device in such a way that a locking of the charging plug in the charging socket is released irrespective of the temperature of the charging socket, in particular directly after the charging process has ended.

A further aspect of the invention relates to a computer program comprising commands that cause the motor vehicle in one of the vehicle variants described above to perform the method steps of the method in one of the method variants described above.

In particular, the commands cause the first or second threshold value for a subsequent charging process to be set depending on an input at the input device. Furthermore, the commands expediently cause the charging, therefore, the charging process of the traction battery, to be controlled in such a way that the temperature of the charging socket does not exceed the first threshold value if the first threshold value has been set. Furthermore, the commands expediently cause the charging of the traction battery to be controlled in such a way that the temperature of the charging socket does not exceed the second threshold value if the second threshold value has been set, wherein preferably the temperature of the charging socket can and/or does exceed the first threshold value.

Expediently, the commands cause the control device to issue commands for and/or to a charging circuit of the motor vehicle and/or commands for and/or to a charging circuit of the charging device. These commands cause the charging current and/or the charging power to be set on the basis of the respective charging circuit in such a way that the set threshold value for the temperature of the charging socket is not exceeded.

A further aspect of the invention relates to a computer-readable medium on which the computer program is stored in one of the variants described above. The computer-readable medium is expediently a non-volatile memory, for example, an SSD (solid-state drive), an HDD (hard disk drive), a mobile plug-and-play storage device, a CD, or a DVD.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an electric-powered motor vehicle with a control device, an input device for a user, a traction battery and a charging socket; and

FIG. 2 is a flowchart of a method sequence for controlling a charging process of the traction battery of the motor vehicle.

### DETAILED DESCRIPTION

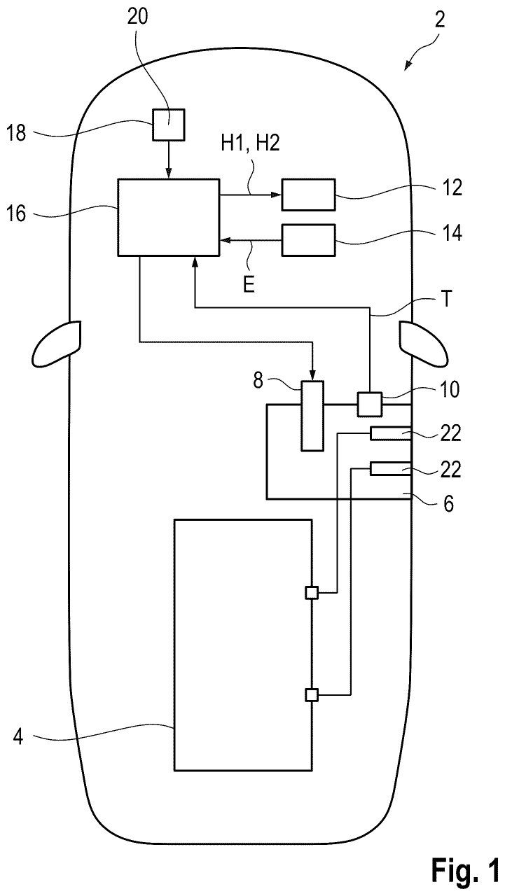

An electric-powered motor vehicle 2, also designated as vehicle 2, is shown schematically in FIG. 1. Vehicle 2 comprises a traction battery 4, which provides electrical energy for a (traction) electric motor of a traction drive of vehicle 2. Traction battery 4 is also known as a high-voltage battery and provides a voltage for a high-voltage network, wherein the voltage is greater than 60 V, for example, between 300 V and 3000 V, in particular between 400 V and 800 V.

A charging socket 6 of vehicle 2 is electrically connected to traction battery 4 for charging the latter and/or can be connected by means of a charging circuit. The charging socket is designed in this case so that a charging plug of a charging device can be plugged into it. Optionally and preferably, charging socket 6 comprises a locking mechanism 8, which is only indicated schematically in FIG. 1. The charging plug can be fixed in charging socket 6 by means of the locking mechanism and thus secured against being pulled out, particularly for the duration of the charging process.

Charging socket 6 also comprises at least one temperature sensor 10 for detecting the temperature T of charging socket 6, in particular for detecting the temperature T of at least one of its electrical contacts (charging socket pins) 22, by means of which current is transferred from the charging device to the traction battery.

Furthermore, vehicle 2 has an input device 12, for example, designed as a touch display, for an input E by a user of vehicle 2.

Optionally, vehicle 2 furthermore comprises an output device 14, such as, for example, a loudspeaker or a display. In particular, if input device 12 is designed as a touch display, input device 12 is also used as output device 14 according to an alternative.

A control device 16 of vehicle 2, designed, for example, as a controller, is connected to input device 12, to locking mechanism 8, to output device 14, and/or to temperature sensor 10 in terms of signal and/or data transmission.

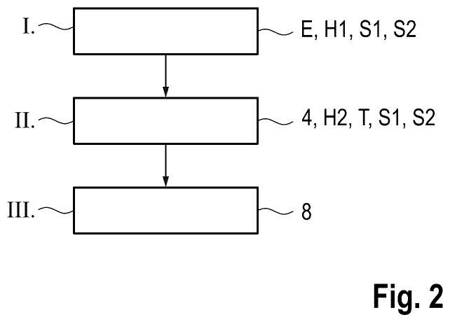

FIG. 2 shows a flowchart that represents a method for charging traction battery 4 of vehicle 2. Vehicle 2, in particular its control device 16, is therefore designed to carry out the method described below. Furthermore, vehicle 2 comprises a memory 18, expediently connected to control device 16, as a computer-readable medium. A computer program 20 is stored on this, which comprises commands that cause vehicle 2 to carry out this method.

In a first step I., an input E made at input device 12 is fed to control device 16. Control device 16 assigns the input E a first threshold value S1 or a second threshold value S2 for the temperature T of charging socket 6 during a charging process of traction battery 4. Furthermore, the first threshold value S1 or second threshold value S2 assigned to input E is set for a charging process. For this purpose, the set threshold value S1 or S2 is stored in memory 18, for example, as the threshold value, to be used for the charging process, for the temperature T of the charging socket. The correspondingly set threshold value S1 or S2 is therefore used for the subsequent charging process.

In summary, the user of vehicle 2 makes an input E using input device 12, wherein the first threshold value S1 or second threshold value S2 for the temperature of charging socket 6 during charging of the traction battery is selected and/or set in accordance with the input.

The first threshold value is between 80° C. and 95° C. The first threshold value between 80° C. and 85° C. is particularly suitable, wherein a risk of burns is assumed at this temperature in accordance with DIN ISO 13732-1:2006 (D) for a contact time of 1 s. The first threshold value thus serves to prevent a burn when touching charging socket 6. The second threshold value S2 has a value between 95° C. and 150° C., in particular between 100° C. and 130° C., and is therefore greater than the first threshold value S1.

In a step II. following the first step I. in time, the charging process of traction battery 4 is controlled by control device 16 in such a way that the temperature T of charging socket 6, in particular its electrical contact, does not exceed the first threshold value S1 if the first threshold value S1 was set in the first step I. However, if the second threshold value S2 was set in the first step I., the charging process of traction battery 4 is controlled by control device 16 in such a way that the temperature T of charging socket 6, in particular its electrical contact, detected by temperature sensor 10 does not exceed the second threshold value S2. The temperature T is expediently detected using the temperature sensor.

For this type of control of the charging process, it is provided that control device 16 issues commands to the charging device. In particular, these commands effect the setting of a charging current and/or a charging power such that heating of the electrical contacts (charging socket pins) of charging socket 6 does not result in the set first threshold value or the set second threshold value S2 being exceeded. To issue these commands, control device 16 is set up, for example, to communicate wirelessly with the charging device. According to an example, the communication can be wired. Expediently, for this purpose, a communication line of control device 16 is connected to a communication pin (communication contact) of charging socket 6, wherein the communication pin can be connected to the charging device, in particular to its charging plug.

Computer program 20 accordingly comprises commands that effect this kind of control of the charging process by means of control device 16.

Optionally and preferably, a notification H1 is output in step I. by means of an output device 14 for carrying out input E. The notification H1 explains the setting options. In particular, the notification H1 includes information that, if the second threshold value S2 is set, there is a risk of burns for the user after the charging process if the user touches charging socket 6. Accordingly, computer program 20 comprises commands that cause output device 14 to output, in particular display, the notification H1.

Optionally and preferably, during and/or according to an alternative subsequent to the charging process of traction battery 4, a further notification H2 is output by means of output device 14 if and/or as soon as the temperature T of charging socket 6 reaches and/or exceeds the first threshold value S1. Accordingly, computer program 20 comprises commands that cause output device 14 to output the further notification H2 if and/or as soon as the temperature T of charging socket 6 reaches and/or exceeds the first threshold value S1.

Optionally and preferably subsequent to the charging process, in particular when no more electrical energy is being transferred from the charging device to traction battery 4 and/or any communication required for this has been completed, in a third step III., the locking mechanism 8 is controlled by control device 16, such that locking of charging socket 6 for the charging plug is released irrespective of the temperature T of charging socket 6. Accordingly, computer program 20 includes commands that cause the locking of charging socket 6 to be released after traction battery 4 has been charged, irrespective of its temperature; therefore, the charging plug is unlocked.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for controlling a charging process of a traction battery of an electric-powered motor vehicle, which comprises the traction battery, a charging socket for charging the traction battery, and an input device for a user, the method comprising:
setting a first threshold value or a second threshold value for a temperature of the charging socket for an electrical contact of the charging socket for a charging process depending on an input at the input device;
setting the first threshold value between 80° C. and 95° C. and setting the second threshold value between 95° C. and 150° C.;
controlling the charging process of the traction battery via a controller of the motor vehicle such that the temperature of the charging socket or its electrical contact does not exceed the first threshold value if the first threshold value has been set; and
controlling the charging process of the traction battery via the control device of the motor vehicle such that the temperature of the charging socket or its electrical contact does not exceed the second threshold value if the second threshold value has been set.

2. The method according to claim 1, wherein a notification is output using an output device of the motor vehicle for carrying out the input, according to which there is a risk of burns for the user when touching the charging socket after the charging process if the second threshold value is set.

3. The method according to claim 1, wherein, when the temperature of the charging socket reaches and/or exceeds the first threshold value, a notification of this is output via the output device or a further output device.

4. The method according to claim 1, wherein, if the second threshold value has been set, a locking of the charging socket for a charging plug is released irrespective of the temperature of the charging socket.

5. An electric-powered motor vehicle comprising:
a traction battery;
a charging socket for charging the traction battery;
an input device for a user; and
a controller to carrying out the method according to claim 1.

6. A computer program comprising commands that cause a motor vehicle to perform the method steps according to claim 1.

7. A computer-readable medium on which the computer program according to claim 6 is stored.
